(19) United States
(12) Patent Application Publication
(10) Pub. No.: US 2015/0239483 A1
(43) Pub. Date: Aug. 27, 2015

(54) ROLLING CADDY AND LOCKING MECHANISM FOR A COOLER

(71) Applicant: Wonderful New Solutions, LLC, Rowlett, TX (US)

(72) Inventor: Scott Floyd, Garland, TX (US)

(21) Appl. No.: 14/616,207

(22) Filed: Feb. 6, 2015

Related U.S. Application Data
(60) Provisional application No. 61/943,686, filed on Feb. 24, 2014.

(51) Int. Cl. B62B 3/04; B62B 3/08

(52) U.S. Cl. CPC B62B 3/04; B62B 3/08

(57) ABSTRACT

A rolling caddy for a cooler may provide a contoured space to receive a cooler such that once a cooler has been positioned within the rolling caddy, a user may simply lift on the corners of the cooler opposite where the rolling caddy has been placed and roll the cooler anywhere he/she wishes to transport the cooler. Use of such a rolling caddy may allow a cooler to be transported by one person. A lock tab also may be used with a rolling caddy for a cooler. Use of a lock tab may further reduce the likelihood of the cooler being stolen and also may serve to maintain the position of the rolling caddy underneath the cooler when in transport, such as when the user is rolling the cooler over rough terrain, in dirt, in fields, or even down steps.

### CROSS-REFERENCE TO RELATED APPLICATION

This application claims priority to U.S. Patent Application Ser. No. 61/943,686 filed on Feb. 24, 2014, entitled “Rolling Caddy and Locking Mechanism for a Yeti-Style Cooler,” which is incorporated reference in its entirety.

### FIELD OF THE DISCLOSURE

The present disclosure generally relates to cooler locking and transport, and more particularly to a rolling caddy and locking mechanism for a cooler.

### BACKGROUND

Coolers, such as YETI-style coolers, are popular for hunting, camping, rafting, and other commercial uses because of their durable construction and ability to keep ice from melting for longer than most ordinary coolers. However, once a cooler is filled with food/drinks and ice, it becomes extremely heavy and may require more than one person to carry it to a desired location.

### SUMMARY

Embodiments of the present disclosure may provide a rolling caddy for a cooler, the rolling caddy comprising a floor plate; at least two footpad pockets disposed within the floor plate to receive footpads of the cooler; a back wall connected to the floor plate at a right angle; and at least two wheels connected to the back plate, wherein when the footpads of the cooler are placed within the at least two footpad pockets, friction between the footpads and the at least two footpad pockets result in the cooler remaining stabilized within the rolling caddy for transport. The back wall may be contoured to match the contour of the corners of the cooler. The back wall may further include curved wall portions that extend forward of the back wall to provide support to the sides of the cooler when the cooler is placed within the rolling caddy. The curved wall portions may curve around the at least two footpad pockets. The rolling caddy also may include a lock tab formed on a top center edge of the back wall, wherein the lock tab connects with a lock bar on the cooler to secure the rolling caddy to the cooler. The rolling caddy also may include a fastening mechanism to affix the lock tab to the lock bar. The fastening mechanism may be a Velcro® strap having a D-ring on one end that hooks to the top center edge of the back plate having the lock tab. The rolling caddy also may include a panel disposed on the back wall facing away from the at least two footpad pockets, the panel displaying advertisements and ownership information.

Other embodiments of the present disclosure may provide a rolling caddy that transports a cooler, the rolling caddy comprising: a floor plate; a back wall connected to the floor plate at a right angle; two footpad pockets disposed within the floor plate at a back edge where the back wall connects with the floor plate, wherein the two footpad pockets receive footpads of the cooler; at least two wheels connected to the back plate; and a lock tab disposed on a top edge of the back wall, wherein when the footpads of the cooler are placed within the at least two footpad pockets and the lock tab is connected to a lock bar disposed on the cooler, the cooler is secured to the rolling caddy for transport. The back wall also may include curved wall portions that support the sides of the cooler. The curved wall portions may extend forward from the back wall to a position just forward of the two footpad pockets. The curved wall portions may extend forward from the back wall to the front edge of the floor plate. The at least two wheels may be positioned equidistant from the lock tab. The lock tab may be formed on a top center edge of the back wall. The rolling caddy also may include a fastening mechanism to affix the lock tab to the lock bar. The fastening mechanism may be a Velcro® strap having a D-ring on one end that hooks to a top center edge of the back plate having the lock tab. The back wall may be contoured to match the contour of the corners of the cooler. The rolling caddy also may include a panel disposed on the back wall facing away from the two footpad pockets, the panel displaying advertisements and ownership information.

Further embodiments may provide a method for utilizing a rolling caddy to transport a cooler, the method comprising: aligning the cooler with curved wall portions on a back wall of the rolling caddy, wherein the curved wall portions support the sides of the cooler; placing footpads on the bottom portion of the cooler with at least two footpad pockets disposed in a floor plate of the rolling caddy; lifting the side of the cooler opposite where the footpads are disposed on the bottom portion of the cooler; and rolling the rolling caddy holding the cooler. The method also may include securing the cooler to the rolling caddy by attaching a lock bar on the cooler to a lock tab disposed on a top edge of the back wall of the rolling caddy.

### BRIEF DESCRIPTION OF THE DRAWINGS

For a more complete understanding of this disclosure, reference is now made to the following description, taken in conjunction with the accompanying drawings, in which:

FIG. 1 depicts a front view of a rolling caddy for a cooler according to an embodiment of the present disclosure;

FIG. 2 depicts a side view of a rolling caddy for a cooler according to an embodiment of the present disclosure;

FIG. 3 depicts a bottom view of a rolling caddy for a cooler according to an embodiment of the present disclosure;

FIG. 4 depicts a back view of a rolling caddy for a cooler according to an embodiment of the present disclosure;

FIG. 5 depicts another back view of a rolling caddy when paired with a cooler according to an embodiment of the present disclosure; and

FIG. 6 depicts another side view of a rolling caddy when paired with a cooler according to an embodiment of the present disclosure.

### DETAILED DESCRIPTION

Embodiments of the present disclosure may provide a rolling caddy that may be positioned relative to a cooler to make it easier to transport, particularly when it is filled with food/drink and ice. Such a rolling caddy may provide a contoured space to receive a cooler such that once the cooler has been positioned within the rolling caddy, a user may simply lift the corners of the cooler opposite where the rolling caddy has been placed under the cooler and roll the cooler anywhere he/she wishes to transport the cooler. This rolling caddy satisfies a long-felt need insofar as cooler manufacturers such as YETI, have not offered any mechanism to make these heavier, more industrial-sized coolers (sometimes referred to herein as “YETI-style coolers”) easier to move, and in addition, cooler manufacturers, such as YETI, have not previously offered these types of coolers having wheels. While these coolers may be referred to as YETI-style coolers, it should be appreciated that the rolling caddy according to embodiments of the present disclosure is not limited to use with coolers manufactured by YETI. Rather, a rolling caddy according to embodiments of the present disclosure may be utilized with any type of heavy, industrial-sized coolers, including but not limited to, ESKY™ Series coolers, Canyon Coolers 125 Outfitter, Ducks Unlimited Summit Series Coolers, Brute Outdoors Brute Box ice chest, Pelican ProGear Elite Coolers/Ice Chests, Grizzly Rotomold Coolers, Titan Series Mammoth Coolers, and Igloo Super Tough Sportsman Coolers.

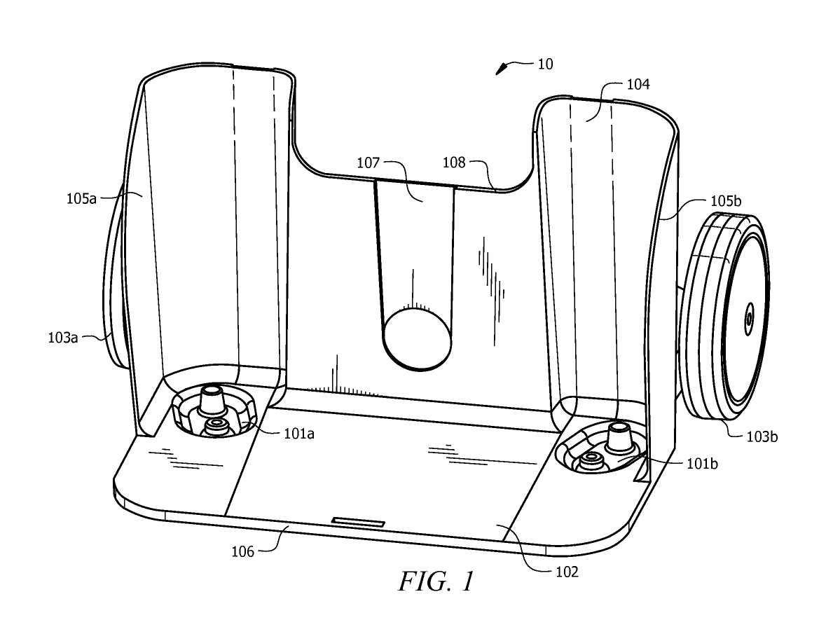

FIG. 1 depicts a front view of rolling caddy 10 for a cooler according to an embodiment of the present disclosure. Rolling caddy 10 may include footpad pockets 101a, 101b in the bottom back section of floor plate 102. Footpad pockets 101a, 101b may be positioned in floor plate 102 so that they may be just forward of wheels 103a, 103b respectively.

Rolling caddy 10 also may include back wall 104 that may connect to floor plate 101 at approximately a right angle wherein back wall 104 is perpendicular to floor plate 101. In embodiments of the present disclosure, rolling caddy 10 may be contoured across back wall 104 extending vertically from floor plate 102 so that the contour generally matches the contour of the corners of a cooler that may be positioned within rolling caddy 10. As such, this contouring may also keep the cooler from sliding back or off rolling caddy 10. Back wall 104 may further include curved wall portions 105a, 105b that may extend forward of back wall 104 to provide further support to the sides of a cooler when the cooler may be placed within rolling caddy 10. Curved wall portions 105a, 105b may curve around footpad pockets 101a, 101b respectively according to an embodiment of the present disclosure. While curved wall portions 105a, 105b are depicted in FIG. 1 as extending forward of back wall 104 to just forward of footpad pockets 101a, 101b, it should be appreciated that there may be embodiments of the present disclosure where curved wall portions 105a, 105b may extend closer to front edge 106 of floor plate 101.

Rolling caddy 10 also may include lock tab 107 used in conjunction with rolling caddy 10 that may be formed in the central portion of back wall 104 according to an embodiment of the present disclosure. Use of lock tab 107 may further reduce the likelihood of the cooler being stolen. Use of lock tab 107 according to embodiments of the present disclosure also may serve to maintain the position of rolling caddy 10 underneath the cooler when in transport, such as when the user is rolling the cooler over rough terrain, in dirt, in fields, or even down steps. Lock tab 107 may work in cooperation with a cooler according to an embodiment of the present disclosure. More specifically, a cooler may include a lock bar that may allow a user to lock the cooler onto the bed of a truck, for example, to reduce the likelihood of the cooler being stolen. When the lock bar is in place, it generally is still loose and the cooler may still be susceptible to being stolen. Utilizing lock tab 107 may serve to remove looseness or play in the lock bar. Lock tab 107 according to an embodiment of the present disclosure may allow a user to attach the cooler to lock tab 107 through a fastening mechanism, including but not limited to a Velcro® strap having a D-ring on one end that may hooked to top edge 108 of back place 104 of rolling caddy 10. Once lock tab 107 is in place and secured to the lock bar of the cooler, this may further reduce the likelihood of the cooler being stolen. Lock tab 107 also may serve to maintain the position or placement of rolling caddy 10 underneath a cooler while in transport, such as when the user is rolling caddy 10 holding a cooler over rough terrain, in dirt, in fields, or even down steps. While lock tab 107 is referred to as a tab, it should be appreciated that other locking mechanisms may be utilized to secure rolling caddy 10 to a lock bar that may be present on a cooler or to the cooler in general, such as a strap, without departing from the present disclosure.

When rolling caddy 10 is placed under the bottom of a cooler, the footpads of the cooler may slide into footpad pockets 101a, 101b. Once the cooler has been placed on rolling caddy 10 and the cooler footpads have been positioned in a secure manner within footpad pockets 101a, 101b, friction may result in the cooler remaining stabilized within rolling caddy 10 during transport. Centrifugal force, along with the natural weight of the cooler (whether full or empty), may contribute to the form fit of rolling caddy 10 along the bottom of the cooler according to embodiments of the present disclosure.

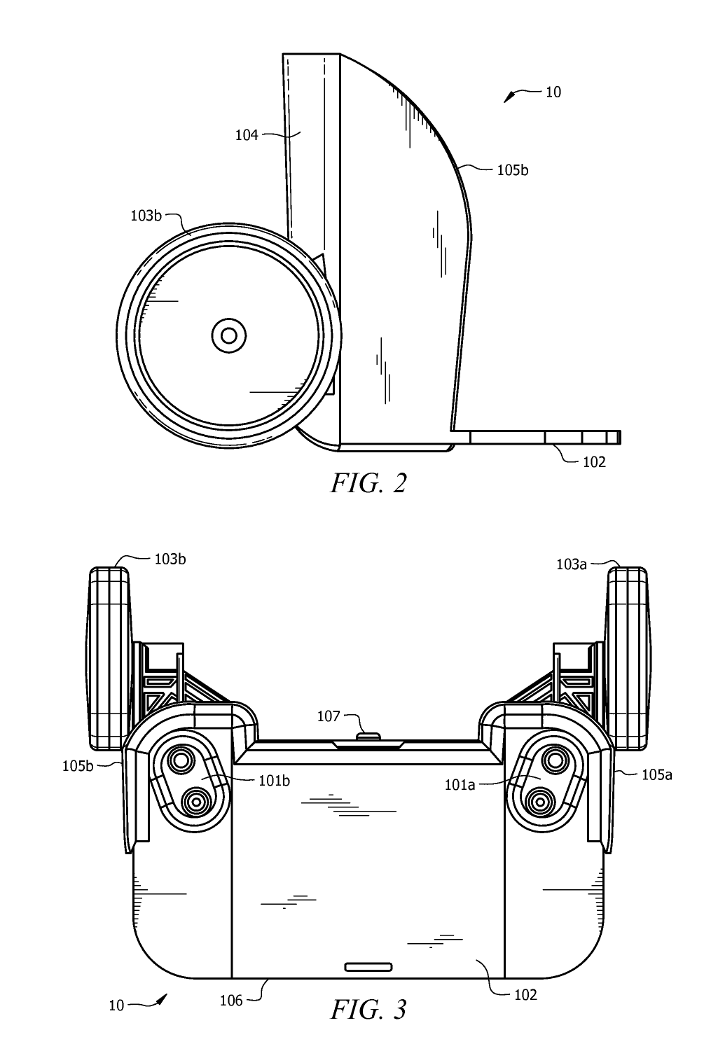

FIG. 2 depicts a side view of rolling caddy 10 for a cooler according to an embodiment of the present disclosure. In this embodiment of the present disclosure, curved wall portion 105b is depicted as extending forward of back plate 104 such that footpad pocket 101b (FIG. 1) is not visible when rolling caddy 10 is viewed from the side. However, it should be appreciated that there may be embodiments of the present disclosure wherein footpad pocket 101b may be visible from the side. While a portion of floor plate 102 is depicted as being visible from the side in FIG. 2, it should be appreciated that there may be embodiments wherein curved wall portion 105b may extend to front edge 106 of floor plate 102 such that curved wall portion 105b fully supports the side of a cooler when placed on floor plate 102. In addition, it should be appreciated that the degree of curvature of curved wall portion 105b may vary without departing from the present disclosure.

FIG. 3 depicts a bottom view of rolling caddy 10 for a cooler according to an embodiment of the present disclosure. The position of footpad pockets 101a, 101b relative to floor plate 102 as well as relative to curved wall portions 105a, 105b may be visible from this view. In this embodiment of the present disclosure, wheels 103a, 103b are depicted as being positioned behind and to the side of curved wall portions 105a, 105b so that they do not jostle the main portion of rolling caddy 10 that supports a cooler when rolling caddy 10 is in motion. However, it should be appreciated that wheels 103a, 103b may be positioned closer or further away from curved wall portions 105a, 105b respectively without departing from the present disclosure. Wheels 103a, 103b may be positioned parallel to one another on rolling caddy 10 and may be positioned equidistant from lock tab 107 according to embodiments of the present disclosure so that the weight of the cooler may be equally balanced on rolling caddy 10.

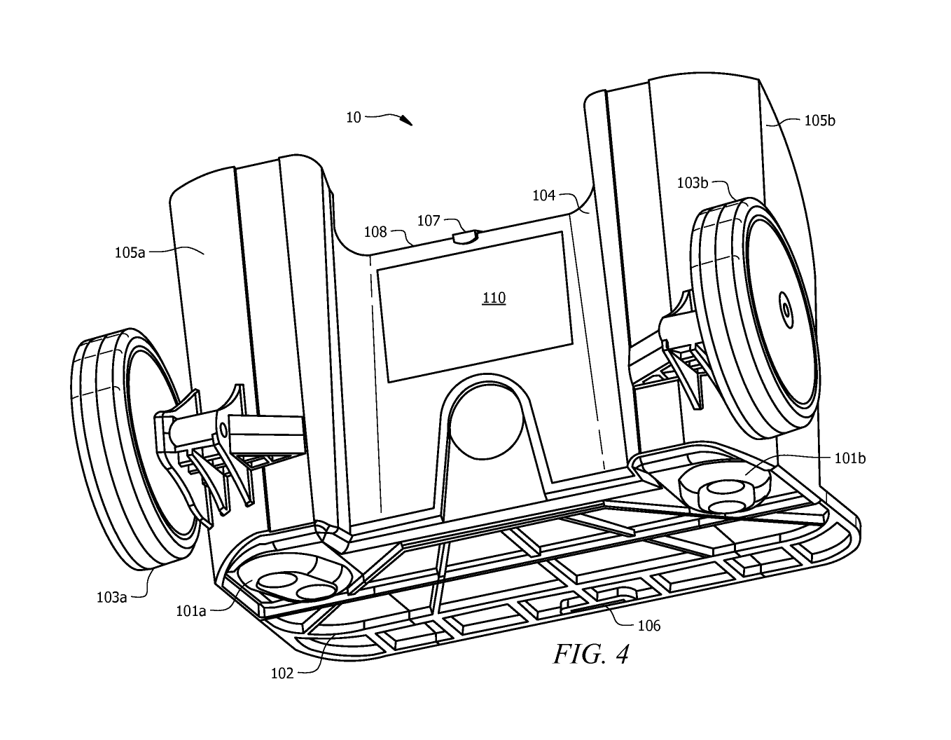

FIG. 4 depicts a back view of rolling caddy 10 for a cooler according to an embodiment of the present disclosure. In this embodiment of the present disclosure, the mechanism to fasten wheels 103a, 103b to curved wall portions 105a, 105b respectively may be depicted. In an embodiment of the present disclosure, back wall 104 may include panel 110 below top edge 108. Panel 110 may include advertising for the manufacturer of rolling caddy 10 according to an embodiment of the present disclosure. In other embodiments of the present disclosure, panel 110 may include a window wherein labels may be interchanged within the window. Additionally or alternatively, panel 110 may provide a user with the ability to write his/her name, for example, on an erasable surface or permanently to identify the owner of rolling caddy 10. It should be appreciated that other means to identify the manufacturer, seller or owner of rolling caddy 10 may be incorporated into panel 110 without departing from the present disclosure.

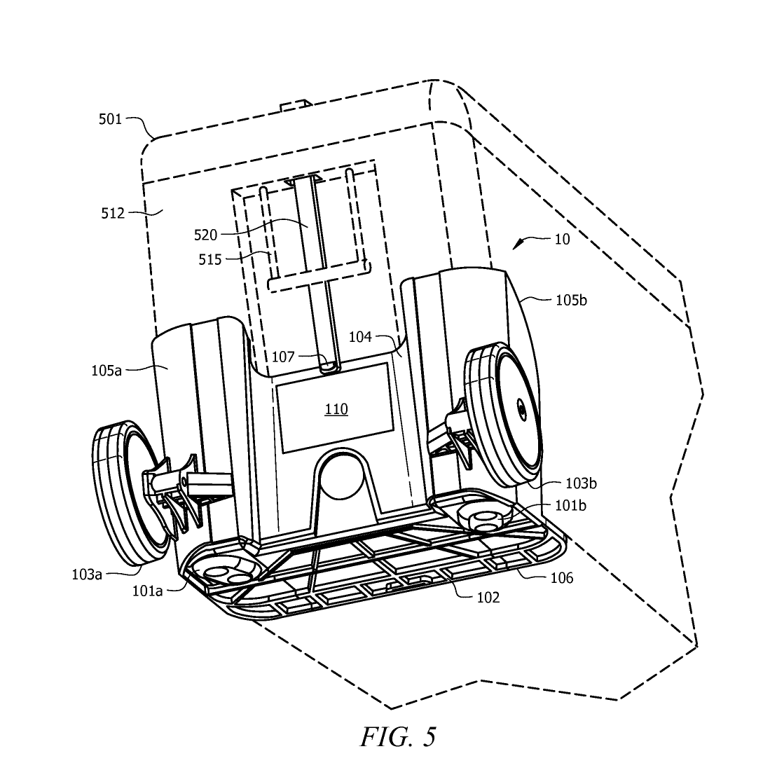

FIG. 5 depicts another back view of rolling caddy 10 when paired with cooler 501 according to an embodiment of the present disclosure. In this embodiment, cooler 501 is depicted when placed on rolling caddy 10. Footpads on the bottom of cooler 501 may lock into footpad pockets 101a, 101b to position cooler 501 relative to floor plate 102. Footpads of cooler 501 may be removable, non-skid rubber footpads to minimize movement within footpad pockets 101a, 101b in embodiments of the present disclosure. However, it should be appreciated that the footpads of cooler 501 may be formed from other materials without departing from the present disclosure.

Cooler 501 may include lock bar 520 and handle 515 on back wall 512 of cooler 501. Cooler 501 may be secured into position on rolling caddy 10 by connecting lock bar 520 of cooler 501 into lock tab 107 that forms part of back plate 104. However it should be appreciated that there may be embodiments of the present disclosure wherein cooler 501 does not include lock bar 520, and accordingly, cooler 501 may be secured to rolling caddy 10 only through securing the footpads of cooler 501 into footpad pockets 101a, 101b.

As depicted in FIG. 5, the height of cooler 501 when locked into position on footpad pockets 101a, 101b may exceed the height of curved wall portions 105a, 105b; however, it should be appreciated that there may be embodiments of the present disclosure wherein the height of curved wall portions 105a, 105b may be equal to or exceed the height of cooler 501 when cooler 501 is locked into position on footpad pockets 101a, 101b. Also, as depicted in FIG. 5, cooler 501 may extend beyond front edge 106 of rolling caddy 10; however, it should be appreciated that there may be embodiments of the present disclosure wherein front edge 106 may extend beyond the front edge of cooler 501.

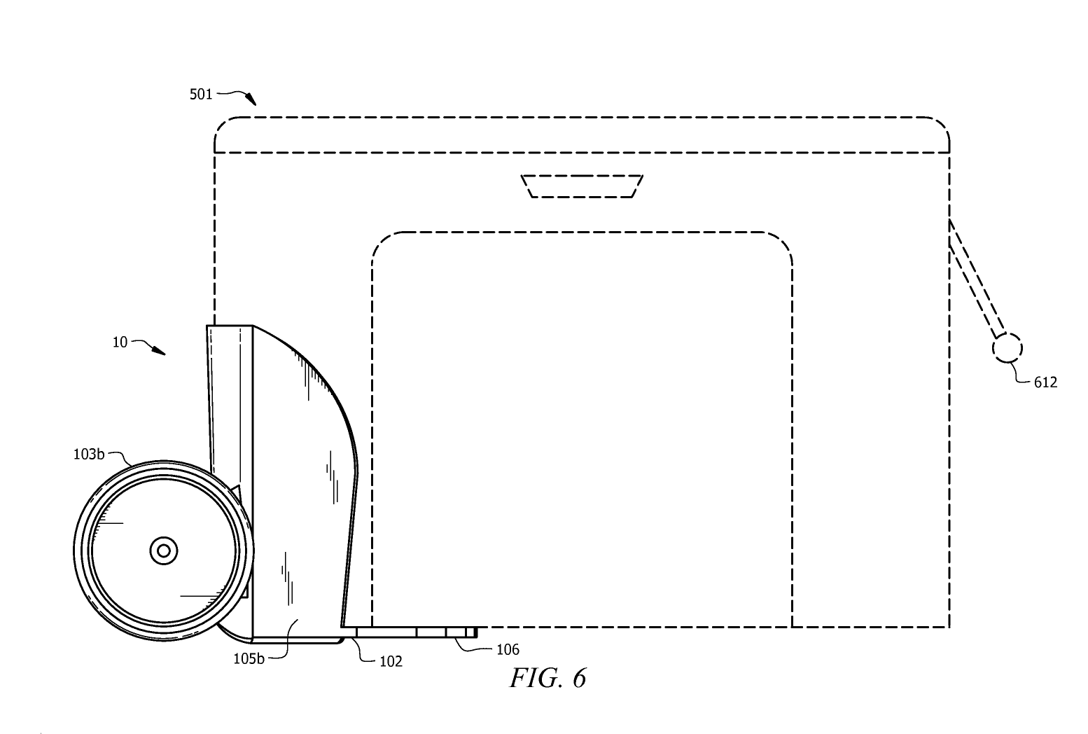

FIG. 6 depicts another side view of rolling caddy 10 when paired with cooler 501 according to an embodiment of the present disclosure. Similar to FIG. 2, in this embodiment of the present disclosure, curved wall portion 105b is depicted as extending forward of back plate 104 such that footpad pocket 101b (FIG. 1) is not visible when rolling caddy 10 is viewed from the side. However, it should be appreciated that there may be embodiments of the present disclosure wherein footpad pocket 101b may be visible from the side. While a portion of floor plate 102 is depicted as being visible from the side in FIG. 6, it should be appreciated that there may be embodiments wherein curved wall portion 105b may extend to front edge 106 of floor plate 102 such that curved wall portion 105b fully supports the side of a cooler when placed on floor plate 102. In addition, it should be appreciated that the degree of curvature of curved wall portion 105b may vary without departing from the present disclosure. Cooler 501 may include handle 612 so that a user may grasp handle 612 when cooler 501 is locked into place on rolling caddy 10 and move both cooler 501 and rolling caddy 10.

It should be appreciated that once a cooler has been positioned within the rolling caddy, the user may simply lift on the corners of the cooler opposite where the rolling caddy has been placed and roll the cooler anywhere he/she wishes to transport the cooler. The wheels affixed to the rolling caddy may assist in moving the cooler when placed within the rolling caddy according to embodiments of the present disclosure. Use of a rolling caddy may allow a cooler to be transported by one person according to embodiments of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A rolling caddy for a cooler, the rolling caddy comprising:
a floor plate;
at least two footpad pockets disposed within the floor plate to receive footpads of the cooler;
a back wall connected to the floor plate at a right angle; and
at least two wheels connected to the back plate,
wherein when the footpads of the cooler are placed within the at least two footpad pockets, friction between the footpads and the at least two footpad pockets result in the cooler remaining stabilized within the rolling caddy for transport.

2. The rolling caddy of claim 1 wherein the back wall is contoured to match the contour of the corners of the cooler.

3. The rolling caddy of claim 1, the back wall further comprising:
curved wall portions that extend forward of the back wall to provide support to the sides of the cooler when the cooler is placed within the rolling caddy.

4. The rolling caddy of claim 3 wherein the curved wall portions curve around the at least two footpad pockets.

5. The rolling caddy of claim 1 further comprising:
a lock tab formed on a top center edge of the back wall, wherein the lock tab connects with a lock bar on the cooler to secure the rolling caddy to the cooler.

6. The rolling caddy of claim 5 further comprising:
a fastening mechanism to affix the lock tab to the lock bar.

7. The rolling caddy of claim 6 wherein the fastening mechanism is a Velcro® strap having a D-ring on one end that hooks to the top center edge of the back plate having the lock tab.

8. The rolling caddy of claim 1 further comprising:
a panel disposed on the back wall facing away from the at least two footpad pockets, the panel displaying advertisements and ownership information.

9. A rolling caddy that transports a cooler, the rolling caddy comprising:
a floor plate;
a back wall connected to the floor plate at a right angle;
two footpad pockets disposed within the floor plate at a back edge where the back wall connects with the floor plate, wherein the two footpad pockets receive footpads of the cooler;
at least two wheels connected to the back plate; and
a lock tab disposed on a top edge of the back wall,
wherein when the footpads of the cooler are placed within the at least two footpad pockets and the lock tab is connected to a lock bar disposed on the cooler, the cooler is secured to the rolling caddy for transport.

10. The rolling caddy of claim 9, the back wall further comprising:
curved wall portions that support the sides of the cooler.

11. The rolling caddy of claim 10 wherein the curved wall portions extend forward from the back wall to a position just forward of the two footpad pockets.

12. The rolling caddy of claim 10 wherein the curved wall portions extend forward from the back wall to the front edge of the floor plate.

13. The rolling caddy of claim 9 wherein the at least two wheels are positioned equidistant from the lock tab.

14. The rolling caddy of claim 9 wherein the lock tab is formed on a top center edge of the back wall.

15. The rolling caddy of claim 9 further comprising:
a fastening mechanism to affix the lock tab to the lock bar.

16. The rolling caddy of claim 15 wherein the fastening mechanism is a Velcro® strap having a D-ring on one end that hooks to a top center edge of the back plate having the lock tab.

17. The rolling caddy of claim 9 wherein the back wall is contoured to match the contour of the corners of the cooler.

18. The rolling caddy of claim 9 further comprising:
a panel disposed on the back wall facing away from the two footpad pockets, the panel displaying advertisements and ownership information.

19. A method for utilizing a rolling caddy to transport a cooler, the method comprising:
aligning the cooler with curved wall portions on a back wall of the rolling caddy, wherein the curved wall portions support the sides of the cooler;
placing footpads on the bottom portion of the cooler with at least two footpad pockets disposed in a floor plate of the rolling caddy;
lifting the side of the cooler opposite where the footpads are disposed on the bottom portion of the cooler; and
rolling the rolling caddy holding the cooler.

20. The method of claim 19 further comprising:
securing the cooler to the rolling caddy by attaching a lock bar on the cooler to a lock tab disposed on a top edge of the back wall of the rolling caddy.
